(19) United States
(12) Patent Application Publication
(10) Pub. No.: US 2005/0146272 A1
(43) Pub. Date: Jul. 7, 2005

(54) Plasma display panel

(76) Inventors: Seong-eui Lee, Seongnam-si (KR); Young-mo Kim, Suwon-si (KR); Hidekazu Hatanaka, Seongnam-si (KR); Seung-hyun Son, Hwaseong-si (KR); Sang-hun Jang, Yongin-si (KR); Ju-hyun Lee, Seoul (KR); Gi-young Kim, Chungju-si (KR); Hyoung-bin Park, Seongnam-si (KR)

Correspondence Address: MCGUIREWOODS, LLP, 1750 TYSONS BLVD, SUITE 1800, MCLEAN, VA, 22102, US

(21) Appl. No.: 11/012,227

(22) Filed: Dec. 16, 2004

(30) Foreign Application Priority Data
Dec. 17, 2003 (KR) 10-2003-0092561

(51) Int. Cl. H01J 17/49

(52) U.S. Cl. 313/582; 313/584; 313/586

(57) ABSTRACT

In a plasma display panel, unit discharge regions arranged in a matrix shape are defined on a surface of a first substrate facing a second substrate, transparent discharge sustain electrodes are formed to face each other on the surface of the substrate, in the unit discharge regions, and bus electrodes are coupled to transparent discharge sustain electrodes to surround the unit discharge regions. Accordingly, discharges may occur evenly in the discharge regions to increase an average luminance. Additionally, a positive column discharge is possible by securing a sufficient discharge distance.

### CROSS REFERENCE TO RELATED APPLICATION

This application claims priority to and the benefit of Korean Patent Application No. 10-2003-0092561, filed on Dec. 17, 2003, which is hereby incorporated by reference for all purposes as if fully set forth herein.

### BACKGROUND OF THE INVENTION

1. Field of the Invention

The present invention relates to a plasma display panel (PDP), and more particularly, to a surface discharge PDP.

2. Discussion of the Background

Generally, discharges occur in parallel with a substrate in a surface discharge PDP. Discharge sustain electrodes may be arranged on a front substrate in such a PDP, thus forming optical passages in pixel areas. Accordingly, the PDP may be formed of an optical transmission material. Indium-tin-oxide (ITO) is typically used as an optical transmission is material and as a transparent electrode material. Since an optical transmission material, such as ITO, may have high resistance, it is selectively used in plasma discharge areas, and low-resistance metal bus lines are often used to transfer electrical signals to the ITO electrodes.

FIG. 1 is a perspective view showing a conventional surface discharge PDP, and FIG. 2 is a sectional view showing a discharge cell structure of the PDP of FIG. 1.

Referring to FIG. 1 and FIG. 2, parallel pairs of transparent discharge sustain electrodes 13a and 13b are formed on a surface of a first substrate 10 facing a second substrate 20, and bus lines 14a and 14b are formed on the discharge sustain electrodes 13a and 13b, respectively. A first dielectric layer 11 covers the discharge sustain electrodes 13a and 13b and the bus lines 14a and 14b, and a protective layer 12 covers the first dielectric layer 11. Address electrodes 22, which are orthogonally arranged to the discharge sustain electrodes 13a and 13b, are formed on the second substrate 20, and a second dielectric layer 23 covers the address electrodes 22. Barrier walls 21 are formed on the second dielectric layer 23 and between the address electrodes 22. Fluorescent layers 24 are formed on the sides of the barrier walls 21 and on portions of the second dielectric layer 23.

U.S. Pat. No. 6,335,592 discloses a surface discharge PDP with an improved discharge characteristic and efficiency obtained by a structure where low-resistance bus electrodes are electrically connected to transparent sustain electrodes, which are formed comprising a plurality of pieces to prevent discharges in undesired areas, such as discharges between adjacent discharge cells or in non-pixel areas.

However, such a structure may not provide uniform-strength discharges in a unit discharge cell. The difference between discharge strengths may be caused by uneven current is supply, which may provide concentrated discharges in a predetermined portion of the discharge cell and weakened or non-existent discharges in other portions. Consequently, a discharge cell's average luminance may deteriorate.

### SUMMARY OF THE INVENTION

The present invention provides a PDP that may reduce a luminance difference in a unit discharge cell, thereby improving the cell's average luminance.

Additional features of the invention will be set forth in the description which follows, and in part will be apparent from the description, or may be learned by practice of the invention.

The present invention discloses a plasma display panel, wherein unit pixel areas arranged in a matrix shape are defined on a surface of a substrate facing the other substrate, in a discharge area formed by two substrates, transparent discharge sustain electrodes are formed to face each other on the surface of the substrate, in the unit pixel areas, and two bus electrodes are connected to the exterior of corresponding transparent discharge sustain electrode to surround the unit pixel areas.

The present invention also discloses a plasma display panel comprising a first substrate and a second substrate facing each other, first and second bus electrodes formed in parallel with discharge areas therebetween, on a surface of the first substrate facing the second substrate, and first and second discharge electrodes connected to the first and second bus lines, on the discharge areas, wherein at least one of the first and second bus electrodes has extended bus lines, which are extended to a predetermined distance toward the discharge area, and the discharge electrodes corresponding to the bus electrodes having the extended bus lines are surrounded by the extended bus lines and connected to the bus electrodes and the extended bus is lines.

The present invention also discloses a plasma display panel comprising a first substrate and a second substrate facing each other, first and second bus electrodes having main bus lines in parallel with discharge areas therebetween and extended bus lines extended from the main bus lines to the discharge areas, on a surface of the first substrate facing the second substrate, and discharge sustain electrodes connected to the first and second bus lines, on the discharge areas, while electrically contacting the corresponding extended bus lines, wherein the discharge sustain electrodes have a plurality of discharge sustain electrode elements.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a perspective view showing a conventional surface discharge PDP.

FIG. 2 is a sectional view showing a discharge structure of the PDP of FIG. 1.

FIG. 3 is a perspective view showing a PDP according to a first exemplary embodiment of the present invention.

FIG. 4 is a perspective view showing bus electrodes in a PDP according to the first exemplary embodiment of the present invention.

FIG. 5 is an enlarged plane view showing the bus electrodes of FIG. 4.

FIG. 6 is a perspective view showing a unit discharge region surrounded by the bus electrodes of FIG. 4.

FIG. 7 shows a discharge structure in a unit discharge region of a PDP according to the first exemplary embodiment of the present invention.

FIG. 8 is a perspective view showing a unit discharge region in a PDP according to a second exemplary embodiment of the present invention.

FIG. 9 is a plane view showing a unit discharge region in a PDP according to the second exemplary embodiment of the present invention.

FIG. 10 shows a discharge structure in a unit discharge region of a PDP according to the second exemplary embodiment of the present invention.

FIG. 11 is a perspective view showing a unit discharge region of a PDP according to a third exemplary embodiment of the present invention.

FIG. 12 is a perspective view showing a unit discharge region of a PDP according to a fourth exemplary embodiment of the present invention.

FIG. 13 is a plane view showing a unit discharge region of a PDP according to a fifth exemplary embodiment of the present invention.

FIG. 14 is a plane view showing a unit discharge region of a PDP according to a sixth exemplary embodiment of the present invention.

FIG. 15 is a perspective view showing barrier walls of a unit discharge region of a PDP according to the sixth exemplary embodiment of the present invention.

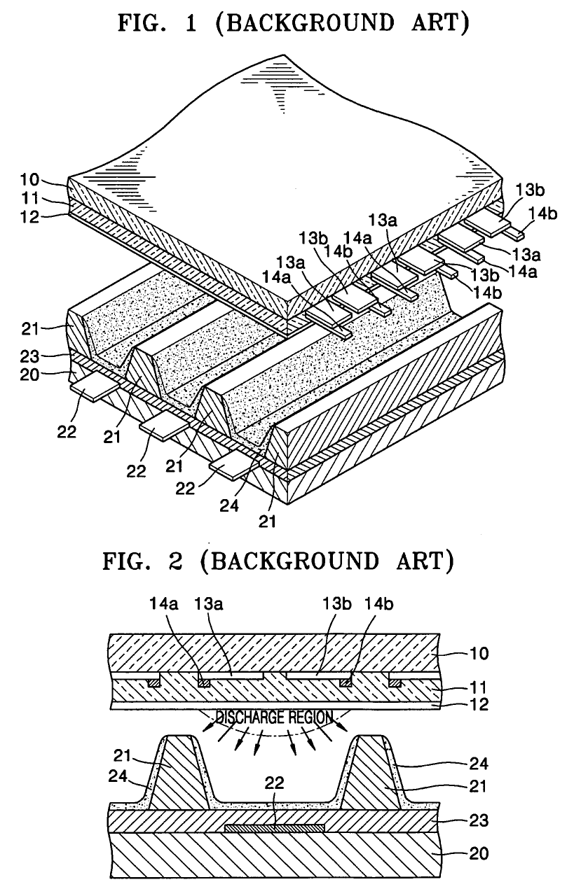

### DETAILED DESCRIPTION OF THE ILLUSTRATED EMBODIMENTS

Exemplary embodiments of the present invention will now be described with reference to the accompanying drawings.

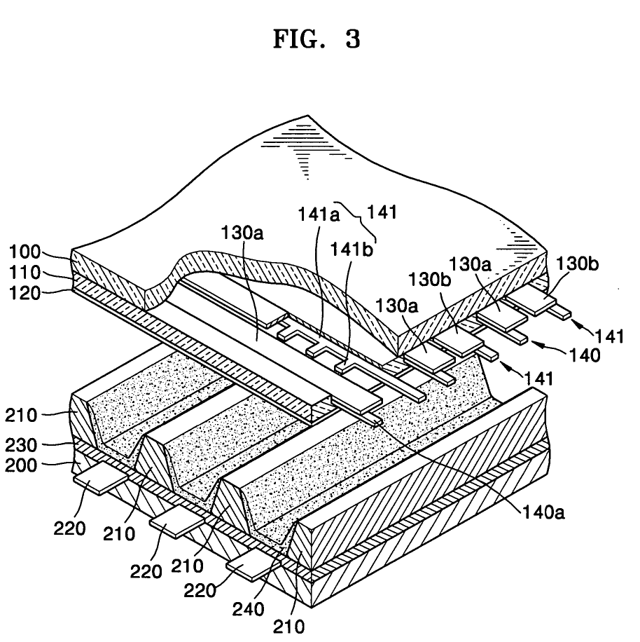

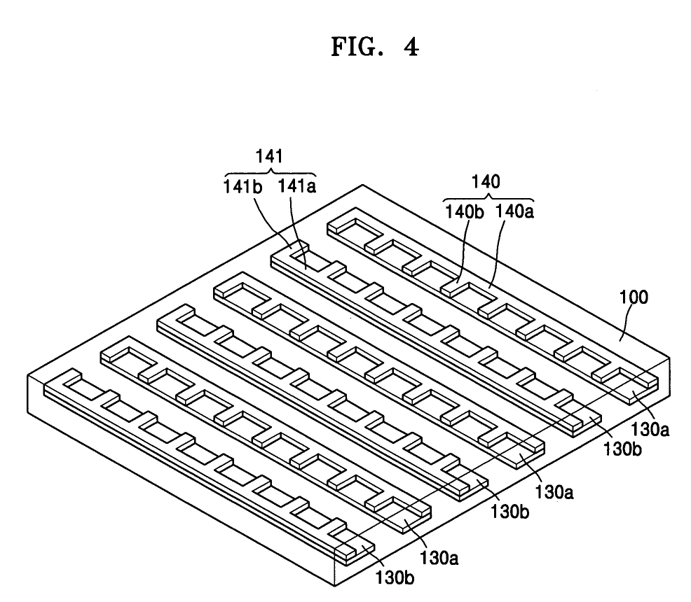

FIG. 3 is a perspective view showing a surface discharge PDP according to a first exemplary embodiment of the present invention, and FIG. 4 is a perspective view showing bus electrodes in the PDP of FIG. 3.

Referring to FIG. 3 and FIG. 4, pairs of band-shaped transparent discharge sustain electrodes 130a and 130b are arranged on a surface of a first substrate 100 facing a second substrate 200, and comb-shaped first and second bus electrodes 140 and 141 are formed on the discharge sustain electrodes 130a and 130b, respectively. The first and second bus electrodes 140 and 141 comprise, respectively, main bus lines 140a and 141a, which are formed in the direction the discharge sustain electrodes 130a and 130b extend, and extended bus lines 140b and 141b, which are formed substantially perpendicular to the main bus lines 140a and 141a. The first and second bus electrodes 140 and 141 are formed to surround a unit discharge region. A first dielectric layer 110 covers the discharge sustain electrodes 130a and 130b and the first and second bus electrodes 140 and 141, and a protective layer 120 covers the first dielectric layer 110. Address electrodes 220, arranged perpendicular to the discharge sustain electrodes 130a and 130b, are formed on the second substrate 200, and a second dielectric layer 230 covers them. Additionally, a plurality of barrier walls 210 are formed on the second dielectric layer 230. The barrier walls 210 may be arranged in parallel with, and in between, the address electrodes 220. Fluorescent layers 240 are formed on the sides of the barrier walls 210 and on portions of the second dielectric layer 230.

Referring to FIG. 4, the band-shaped first and second discharge sustain electrodes 130a and 130b are alternately arranged on the first substrate 100, and the comb-shaped first and second bus electrodes 140 and 141 are formed on the discharge sustain electrodes 130a and 130b, respectively. The discharge sustain electrodes 130a and 130b are formed of a transparent material, such as ITO, and the first and second bus electrodes 140 and 141 are formed of a metal having a low resistance.

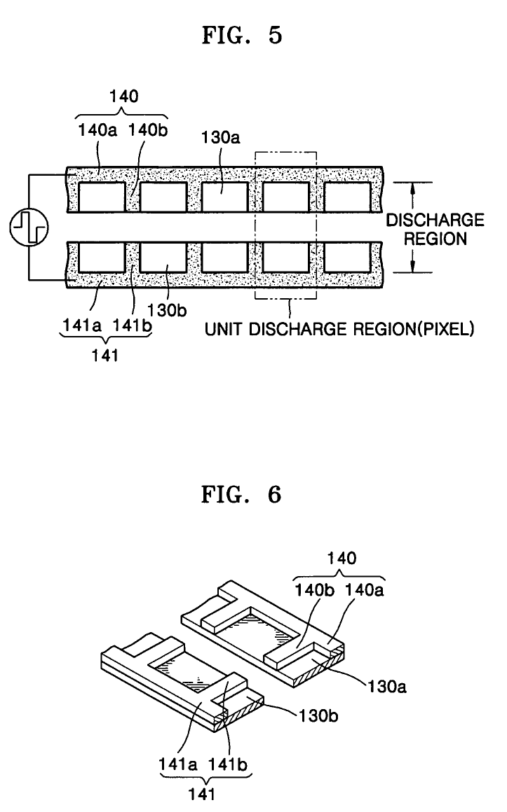

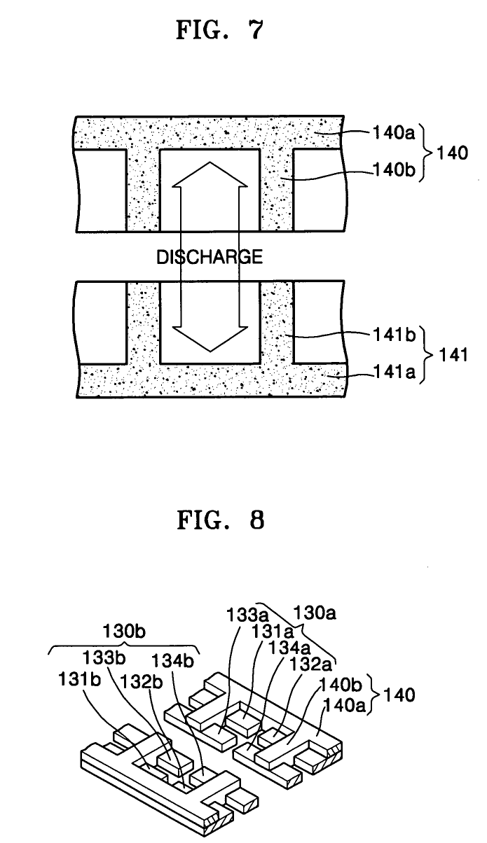

FIG. 5 is a plane view showing the relationship between the discharge sustain electrodes and the bus electrodes in a PDP according to the first exemplary embodiment of the present invention. FIG. 6 is a perspective view showing a unit discharge region of the PDP according to the first exemplary embodiment of the present invention, and FIG. 7 shows a discharge structure in the unit discharge region.

Referring to FIG. 5 and FIG. 6, the transparent discharge sustain electrodes 130a and 130b are formed at both sides of a discharge region in a line shape. The main bus lines 140a and 141a and the extended bus lines 140b and 141b of the comb-shaped bus electrodes 140 and 141 are formed to surround the unit discharge regions, or pixels.

Accordingly, the resistance of the first and second discharge sustain electrodes 130a and 130b may decrease, thus current supplied to them may increase. As a result, as shown in FIG. 7, the discharge may occur on the entire surface of the first and second discharge sustain electrodes 130a and 130b, and a substantially uniform discharge may occur in the unit discharge region.

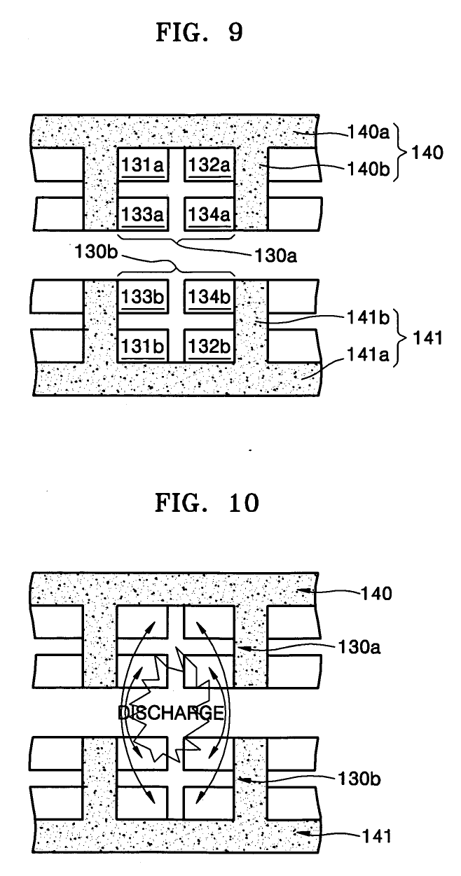

FIG. 8 is a perspective view showing a PDP according to a second exemplary embodiment of the present invention in which bus electrodes are formed in a comb shape and discharge sustain electrodes are separately formed as tile shapes, and FIG. 9 is a plane view showing a PDP according to the second exemplary embodiment of the present invention.

Referring to FIG. 8 and FIG. 9, a first discharge sustain electrode 130a includes discharge sustain electrode elements 131a, 132a, 133a, and 134a, and a second discharge sustain electrode 130b includes discharge sustain electrode elements 131b, 132b, 133b, and 134b. Here, the discharge sustain electrode elements 131a, 132a, 133a, 134a, 131b, 132b, 133b, and 134b extend from extended bus lines 140b and 141b. Additionally, the discharge sustain electrode elements 131a, 132a, 131b, and 132b contact the main bus lines 140a and 141a.

Accordingly, when a discharge occurs as shown in FIG. 10, discharges may separately occur between the discharge sustain electrode elements 131a, 132a, 133a, 134a, 131b, 132b, 133b, and 134b. Consequently, the discharge may take place substantially over the entire unit discharge region.

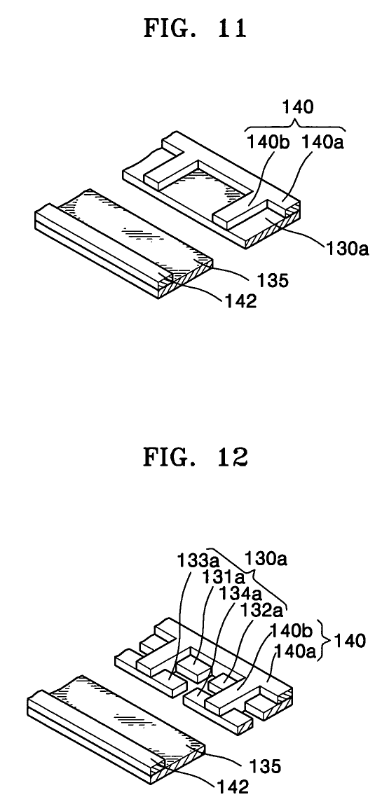

In the PDPs according to the first and second exemplary embodiments, the first and second bus electrodes are symmetrically formed around a discharge region. As shown in FIG. 11 and FIG. 12, PDPs according to third and fourth exemplary embodiments of the present invention have a comb-shaped bus electrode 140 at one side of a discharge region while having a conventional band-shaped discharge sustain electrode 135 and bus electrode 142 at the other side.

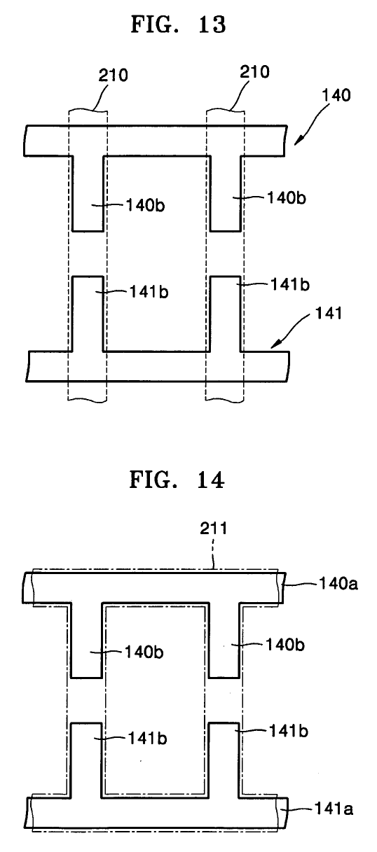

In a PDP according to a fifth exemplary embodiment of the present invention shown in FIG. 13, extended bus lines 140b and 141b are formed corresponding to barrier walls 210, which are arranged between the first substrate 100 and the second substrate 200. Thus, the extended bus lines 140b and 141b overlap the barrier walls 210. Accordingly, discharges between facing bus lines may be prevented, and a reduction of aperture ratio, due to the extended bus lines, may be prevented.

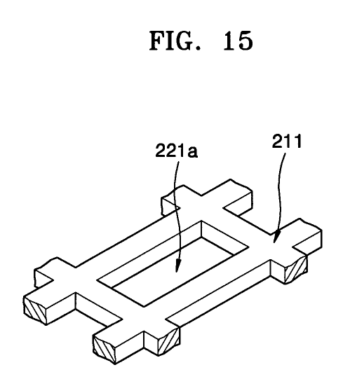

In a PDP according to a sixth exemplary embodiment of the present invention shown in FIG. 14 and FIG. 15, barrier walls 211 are formed in a rectangular lattice or matrix shape, thereby forming a plurality of rectangular through holes 221a. Here, a rectangular through hole 221a corresponds to a unit discharge region, and main bus lines 140a and 141a and extended bus lines 140b and 141b are formed corresponding to the barrier walls 211.

Accordingly, a discharge between first and second discharge sustain electrodes formed in the unit discharge region may be evenly induced. Thus, the difference of discharge strengths may be reduced to generate a uniform luminance and increase an average luminance. Additionally, the uniform discharge obtains a positive column discharge due to an extended discharge distance to generate strong vacuum ultraviolet rays.

A PDP according to exemplary embodiments of the present invention may generate uniform discharges over unit discharge regions, thereby improving an average luminance and generating a large amount of ultraviolet rays.

A PDP according to the present invention may be utilized in a device using a plasma discharge, such as a flat display panel.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A plasma display panel (PDP), comprising:
unit discharge regions arranged in a matrix shape on a surface of a first substrate facing a second substrate;
a first transparent discharge sustain electrode facing a second transparent discharge sustain electrode in a unit discharge region; and
a first bus electrode coupled to the first transparent discharge sustain electrode and a second bus electrode coupled to the second transparent discharge sustain electrode,
wherein the first and second bus electrodes surround the unit discharge region.

2. The PDP of claim 1, wherein the first and second transparent discharge sustain electrodes comprise a plurality of pieces.

3. A plasma display panel (PDP), comprising:
a first substrate and a second substrate facing each other;
first and second discharge sustain electrodes formed in pairs on a surface of the first substrate facing the second substrate; and
a first bus electrode formed on the first discharge sustain electrodes and a second bus electrode formed on the second discharge sustain electrodes,
wherein the first and second bus electrodes are formed in parallel to each other with discharge regions therebetween,
wherein the first and second discharge sustain electrodes are formed in the discharge regions,
wherein at least one of the first and second bus electrodes has extended bus lines that extend toward the discharge regions.

4. The PDP of claim 3, wherein the bus electrodes having extended bus lines comprise:
a main bus line extending along an extended direction of the discharge sustain electrodes,
wherein the extended bus lines are substantially perpendicular to the main bus line.

5. The PDP of claim 4, wherein the first and second bus electrodes have the extended bus lines and are symmetrical to each other while centering the discharge regions therebetween.

6. The PDP of claim 3, further comprising:
barrier walls formed between the first substrate and the second substrate,
wherein the extended bus lines overlap the barrier walls.

7. The PDP of claim 4, further comprising:
barrier walls formed between the first substrate and the second substrate,
wherein the extended bus lines overlap the barrier walls.

8. The PDP of claim 5, further comprising:
barrier walls formed between the first substrate and the second substrate,
wherein the extended bus lines overlap the barrier walls.

9. The PDP of claim 3, further comprising:
barrier walls formed in a matrix shape between the first substrate and the second substrate,
wherein the bus electrodes having extended bus lines comprise a main bus line extending along an extended direction of the discharge sustain electrodes, and
wherein the main bus line and the extended bus lines overlap the barrier walls.

10. The PDP of claim 4, further comprising:
barrier walls formed in a matrix shape between the first substrate and the second substrate,
wherein the main bus line and the extended bus lines overlap the barrier walls.

11. The PDP of claim 5, further comprising:
barrier walls formed in a matrix shape between the first substrate and the second substrate,
wherein the main bus line and the extended bus lines overlap the barrier walls.

12. A plasma display panel (PDP), comprising:
a first substrate and a second substrate facing each other;
first and second discharge sustain electrodes formed in pairs on a surface of the first substrate facing the second substrate;
a first bus electrode formed on the first discharge sustain electrodes and a second bus electrode formed on the second discharge sustain electrodes;
wherein the first and second bus electrodes comprise a main bus line and extended bus lines;
wherein the main bus lines are formed in parallel with each other with discharge regions therebetween;
wherein the extended bus lines extend from the main bus lines toward the discharge regions;
wherein the discharge sustain electrodes are formed in the discharge regions; and
wherein the discharge sustain electrodes comprise a plurality of discharge sustain electrode elements.

13. The PDP of claim 12, wherein the first and second bus electrodes are symmetrical to each other while centering the discharge regions therebetween.

14. The PDP of claim 12, wherein the discharge sustain electrode elements extend from the extended bus lines in a direction parallel with the main bus lines.

15. The PDP of claim 13, wherein the discharge sustain electrode elements extend from the extended bus lines in a direction parallel with the main bus lines.

16. The PDP of claim 12, further comprising:
barrier walls formed between the first substrate and the second substrate,
wherein the extended bus lines overlap the barrier walls.

17. The PDP of claim 13, further comprising:
barrier walls formed between the first substrate and the second substrate,
wherein the extended bus lines overlap the barrier walls.

18. The PDP of claim 12, further comprising:
barrier walls formed in a matrix shape between the first substrate and the second substrate,
wherein the main bus lines and the extended bus lines overlap the barrier walls.

19. The PDP of claim 13, further comprising:
barrier walls formed in a matrix shape between the first substrate and the second substrate,
wherein the main bus lines and the extended bus lines overlap the barrier walls.
